(19) United States
(12) Patent Application Publication
(10) Pub. No.: US 2013/0265278 A1
(43) Pub. Date: Oct. 10, 2013

(54) TOUCH SENSING DEVICE AND CONTROL METHOD THEREOF

(71) Applicant: SAMSUNG ELECTRONICS CO., LTD., Suwon-si (KR)

(72) Inventors: Youngtae SON, Suwon-si (KR); Jong Kang PARK, Hwaseong-si (KR); Haeyong AHN, Hwaseong-si (KR); YoonKyung CHOI, Seoul (KR)

(73) Assignee: SAMSUNG ELECTRONICS CO., LTD., Suwon-si (KR)

(21) Appl. No.: 13/857,727

(22) Filed: Apr. 5, 2013

(30) Foreign Application Priority Data
Apr. 5, 2012 (KR) 10-2012-0035559

(51) Int. Cl. G06F 3/044

(52) U.S. Cl. CPC G06F 3/044
USPC 345/174

(57) ABSTRACT

A touch sensing device and control method thereof, in which a touch state of a node of a touch panel is determined according to a reference value of a reference node.

### CROSS-REFERENCE TO RELATED APPLICATIONS

This application claims priority from Korean Patent Application No. 10-2012-0035559 filed Apr. 5, 2012, in the Korean Intellectual Property Office, the entire contents of which are hereby incorporated by reference.

### BACKGROUND

Methods and apparatuses consistent with the exemplary embodiments relate to a touch sensing device and a control method thereof, and more particularly, to a touch sensing device capable of improving a touch sensing performance using a capacitive sensor and a control method thereof.

In recent years, mobile communication devices and computing devices have adopted a touch sensing device, such as a touch screen, as an input means. The touch sensing device may recognize a user's touch by detecting a variation of an electrical signal generated when the user touches a touch panel. A computing processor connected with the touch sensing device may analyze the user's touch according to a user interface, and may perform various operations according to the analysis result.

The touch sensing device may utilize various manners, such as resistive overlay, capacitive overlay, acoustic surface wave, infrared, surface acoustic wave, inductive, and the like. In particular, the capacitive overlay may be advantageous for multi touch. As a user interface using the multi touch increases, applicability of the touch sensing device using the capacitive overlay may also increase.

### SUMMARY

According to an aspect of an exemplary embodiment, there is provided a control method of controlling a touch sensing device including receiving a first sensing signal that indicates a first capacitance value detected by a first sensing node of a touch panel and a second sensing signal that indicates a second capacitance value detected by a second sensing node of the touch panel; determining a node deviation that is a difference between the first capacitance value and the second capacitance value; determining a first corrected capacitance value of the first sensing node that is a difference between the first capacitance value and the node deviation and a second corrected capacitance value of the second sensing node that is a difference between the second capacitance value and the node deviation; determining one of the first corrected capacitance value of the first sensing node and the second corrected capacitance value of the second sensing node as a reference value; and determining a touch state of one of the first sensing node and the second sensing node based on the reference value and the one of the first corrected capacitance value and the second corrected capacitance value that is not the reference value.

The reference value may be a maximum value of the first corrected capacitance value and the second corrected capacitance value.

The control method further includes determining that the touch state indicates an occurrence of a touch on the touch panel; and calculating a touch coordinate of the touch panel in response to determining that the touch state indicates the occurrence of the touch on the touch panel.

The calculating a touch coordinate of the touch panel includes determining a difference between the reference value and the one of the first corrected capacitance value and the second corrected capacitance value that is not the reference value; and comparing the difference with a comparison value.

The control method further includes providing the touch coordinate to an application processor.

The correcting the touch data includes adding the node deviations to the touch data.

According to an aspect of an exemplary embodiment, there is provided a control method of a touch sensing device including receiving an offset level from a touch panel; calculating a level difference between the input offset level and a target offset level; and varying an offset compensation value of the touch panel according to the level difference.

The offset compensation value may be determined according to a value obtained by dividing the level difference by a reference offset variation amount.

According to an aspect of an exemplary embodiment, there is provided a touch sensing device including a touch panel unit including a first sensing node that detects a first capacitance value and a second sensing node that detects a second capacitance value; and a control unit configured to determine a node deviation that is a difference between the first capacitance value and the second capacitance value, determine a first corrected capacitance value of the first sensing node that is a difference between the first capacitance value and the node deviation and a second corrected capacitance value of the second sensing node that is a difference between the second capacitance value and the node deviation, determine one of the first corrected capacitance value of the first sensing node and the second corrected capacitance value of the second sensing node as a reference value, and determine a touch state of one of the first sensing node and the second sensing node based on the reference value and the one of the first corrected capacitance value and the second corrected capacitance value that is not the reference value.

The touch sensing device further includes a storage unit configured to store the node deviation and the reference value.

The touch state of one of the first sensing node and the second sensing node having the reference value is a no-touch state.

the reference value may be a maximum value of the first corrected capacitance value and the second corrected capacitance value.

The control unit calculates a touch coordinate of the touch panel unit by determining a difference between the reference value and the one of the first corrected capacitance value and the second corrected capacitance value that is not the reference value and comparing the difference with a comparison value.

The touch panel unit includes a sense node array including the first sensing node and the second sensing node arranged at intersections of driving lines and sensing lines; a driver configured to provide a driving current to the driving lines; and a receiver configured to sense the first capacitance value and the second capacitance value.

A signal process unit includes an analog-to-digital converter.

### BRIEF DESCRIPTION OF THE FIGURES

The above and other aspects will become apparent from the following description with reference to the following figures, wherein like reference numerals refer to like parts throughout the various figures unless otherwise specified, and wherein:

FIG. 1 is a block diagram schematically illustrating a touch sensing device according to an exemplary embodiment.

FIG. 2 is a block diagram schematically illustrating a touch panel unit in FIG. 1.

FIG. 3 is a detailed diagram illustrating a sensing node in FIG. 2.

FIG. 4 is a block diagram illustrating a signal process unit in FIG. 1.

FIG. 5 is a flowchart illustrating a control method of a touch sensing device according to an exemplary embodiment.

FIGS. 6A to 6C are diagrams for describing a control method of a conventional touch sensing device.

FIGS. 7A to 7C are diagrams for describing a touch coordinate calculating method of a touch sensing device according to an exemplary embodiment.

FIGS. 8A and 8B are diagrams for describing methods of controlling a touch sensing device.

FIG. 9 is a flowchart illustrating a control method of a touch sensing device according to an exemplary embodiment.

FIG. 10 is a diagram schematically illustrating a handheld phone to which a touch sensing device is applied.

FIG. 11 is a diagram schematically illustrating a personal computer to which a touch sensing device is applied.

### DETAILED DESCRIPTION OF EXEMPLARY EMBODIMENTS

Exemplary embodiments will be described in detail with reference to the accompanying drawings. The exemplary embodiments, however, may be embodied in various different forms, and should not be construed as being limited only to the illustrated exemplary embodiments. Rather, these exemplary embodiments are provided as examples so that this disclosure will be thorough and complete, and will fully convey the concept of the disclosure to those skilled in the art. Accordingly, known processes, elements, and techniques are not described with respect to some of the exemplary embodiments. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular exemplary embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

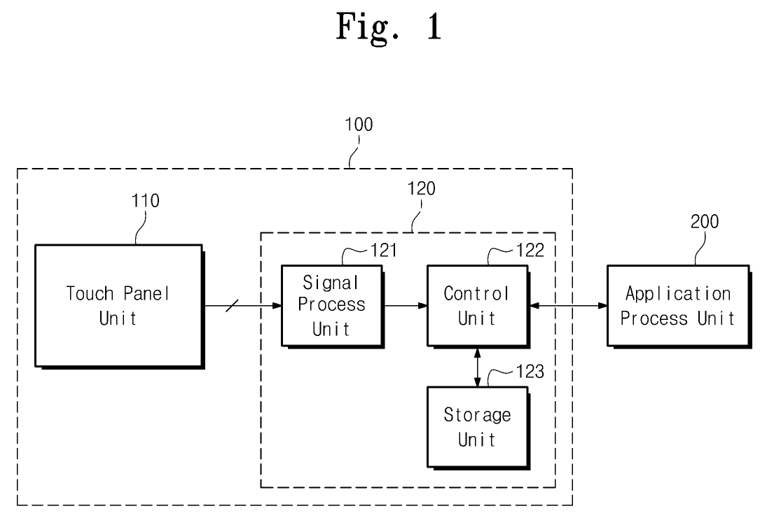

FIG. 1 is a block diagram schematically illustrating a touch sensing device according to an exemplary embodiment. Referring to FIG. 1, a touch sensing device 100 according to an exemplary embodiment may include a touch panel unit 110 and a panel scan unit 120. The panel scan unit 120 may include a signal process unit 121, a control unit 122, and a storage unit 123. The touch sensing device 100 may be configured to interface with an application process unit 200.

The touch panel unit 110 may include a plurality of sensing nodes (not shown). The touch panel unit 110 may convert a touch of a user into an electrical signal, and provide the electrical signal to the signal process unit 121.

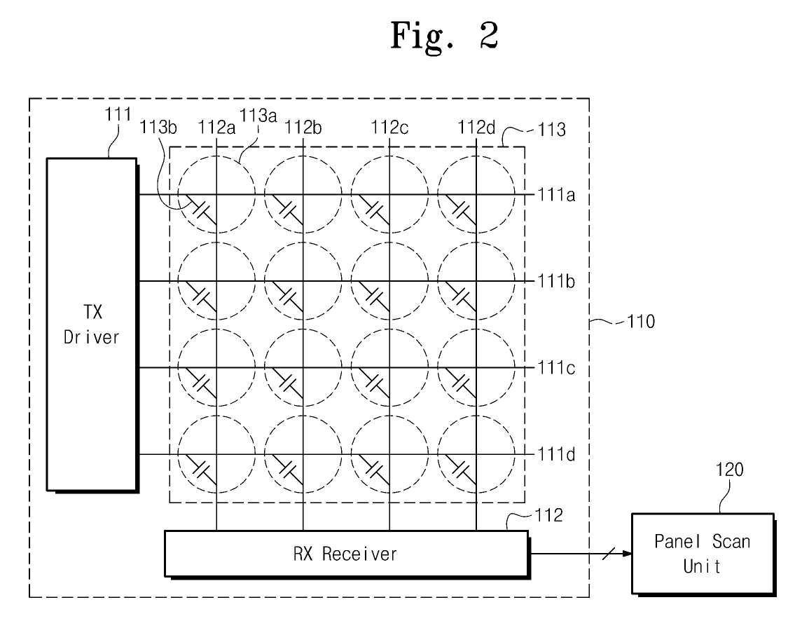

In detail, the touch panel unit 110 may sense mutual capacitance values of the sensing nodes generated by the touch of the user. The touch panel unit 110 may provide the signal process unit 121 with an electrical signal indicating a sensed mutual capacitance value. This will be more fully described with reference to FIG. 2.

In exemplary embodiments, the touch panel unit 110 may include a display device for providing a user interface or a display. The touch panel unit 110 may include a liquid crystal device (LCD), a field emission display device (FED), an organic light emitting display (OLED), or a plasma display device (PDP).

The signal process unit 121 may generate touch data by processing signals received from the touch panel unit 110. The touch data may indicate a touch state of a touch panel or mutual capacitance values of the sensing nodes in the touch panel unit 110.

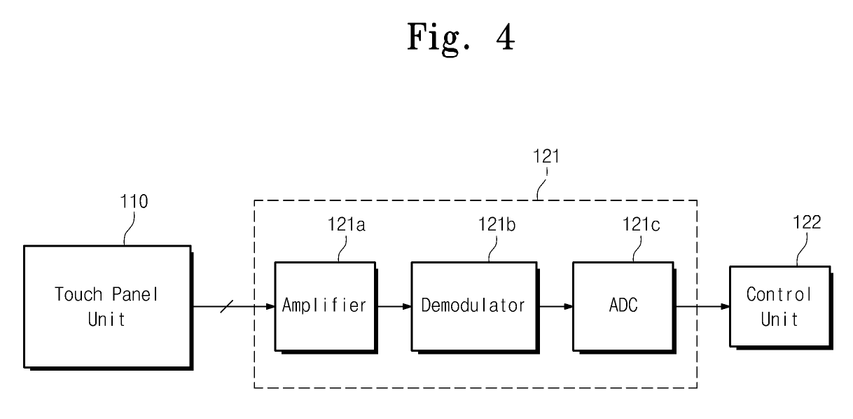

In exemplary embodiments, the signal process unit 121 may include an analog-to-digital converter (hereinafter, referred to as an ADC). In this case, the signal process unit 121 may receive an analog signal. The ADC of the signal process unit 121 may convert an input analog signal into a digital signal to output the digital signal as the touch data. This will be more fully described with reference to FIG. 4.

The control unit 122 may determine a reference value for judging a touch state of a touch panel based on the touch data. In detail, the control unit 122 may correct touch data based on node deviations among the sensing nodes. Herein, a node deviation may be a difference between mutual capacitance values of sensing nodes at a state where a user does not touch a touch panel (hereinafter, referred to as a no-touch state) or a difference between sensing signal magnitudes (hereinafter, referred to as no-touch data) corresponding to the mutual capacitance values.

In exemplary embodiments, a deviation of each sensing node may mean a difference between the largest value of no-touch data and no-touch data of each sensing node. For example, it is assumed that no-touch data of five sensing nodes are 300, 320, 400, 410, and 310, respectively. In this case, deviations of the sensing nodes may be 110, 90, 10, 0, and 100 on the basis of the no-touch data of 410 (the largest value among the no touch data), respectively. Such deviations of sensing nodes may be generated according to a fabricating process or a variation in circumstance, and may be irrelevant to an effective touch of a user. According to the exemplary embodiments, an error of a mutual capacitance value of each sensing node due to a fabricating process or a variation in circumstance may be removed by correcting touch data according to a deviation of each sensing node.

In exemplary embodiments, correction of touch data may be performed by adding a deviation of each sensing node to touch data.

In exemplary embodiments, a deviation of each sensing node may be measured at an initial test level, and may be stored at the storage unit 123. In this case, the control unit 122 may read a deviation of each sensing node from the storage unit 123 to correct touch data.

The control unit 122 may determine a reference value based on corrected touch data. Herein, the reference value may mean a mutual capacitance magnitude of a sensing node, which is not touched, or a magnitude of a sensing signal corresponding to the mutual capacitance magnitude. That is, the reference value may correspond to no-touch data of a sensing node. The control unit 122 may analyze touch data based on the reference value to determine differences between the touch data and the reference value, and may judge a touch state of each sensing node using a magnitude of the differences of the analysis result.

In general, no-touch data may be measured at a specific point of time in advance, and the measured no-touch data may be stored. The stored no-touch data may be used to analyze input touch data. However, in case that no-touch data actually sensed according to a variation in a circumstance is different from previously stored no-touch data, an error may be generated when touch data is analyzed. This error may cause an abnormal operation when a touch state of a touch panel is judged.

According to an exemplary embodiment, a current reference value may be calculated from input touch data without using predetermined no-touch data. As described above, the reference value may indicate a mutual capacitance value of a sensing node not touched or a magnitude of a sensing signal corresponding thereto. A touch state of each sensing node may be judged by analyzing touch data using a calculated reference value. Thus, although no-touch data is varied according to a variation in a circumstance, it is possible to judge a touch state of a touch panel exactly.

A reference value may be determined as follows. Touch data may include a mutual capacitance value of a sensing node touched by a user and a mutual capacitance value of a sensing node not touched. The touch data may be touch data corrected in light of a node deviation. In general, a mutual capacitance value of a touched sensing node may be smaller than that of a sensing node not touched.

Thus, the possibility that a relatively large value of touch data indicates a mutual capacitance value of a sensing node not touched may be high. For this reason, a touch state of a touch panel may be judged by determining a relatively large value of touch data as a reference value and comparing the reference value and a magnitude of another touch data.

In exemplary embodiments, when a difference between the reference value and a magnitude of touch data is greater than a predetermined value, the touch data may be judged to be touch data indicating a touch state. When a difference between the reference value and a magnitude of touch data is less than a predetermined value, the touch data may be judged to be touch data indicating a no-touch state.

In the event that all sensing nodes are touched, all touch data values may indicate a capacitance value of a touch sensing node. Thus, it is possible that a valid reference value is not calculated from touch data.

However, in general, the case that all sensing nodes are touched at the same time may be uncommon. Thus, a method of determining a reference value from input touch data as described above may be applied to a touch sensing device.

Based on a touch state judgment result, the control unit 122 may calculate touch coordinates of touched sensing nodes. The control unit 122 may provide the application process unit 200 with the calculated touch coordinates.

The control unit 122 may compensate an offset level of the touch sensing device 100. The control unit 122 may receive offset levels of mutual capacitance values of sensing nodes included in the touch sensing device 100. The control unit 122 may calculate differences between the offset levels and target offset levels.

In exemplary embodiments, if a calculated level difference is within an error range, the control unit 122 may judge an input offset level to reach a target offset level. In this case, an offset level may not be compensated by the control unit 122.

In a case where the calculated level difference is outside the error range, the control unit 122 may compensate an offset level of the touch sensing device 100. In case that an offset level is compensated stepwise, the control unit 122 may compensate an offset level once by a predetermined magnitude, and may again receive an offset level. The control unit 122 may judge whether a difference between an input offset level and a target offset level exists. If a difference between an input offset level and a target offset level exists, the control unit 122 may compensate an offset level once more by the predetermined magnitude, and may again receive an offset level. Afterwards, the control unit 122 may iteratively compensate an offset level until an offset level of the touch sensing device 100 reaches a target offset level.

In case that a difference between an offset level of the touch sensing device 100 and a target offset level is very large, it may take a lot of time to compensate an offset level using the above-described manner.

Thus, the control unit 122 may be configured to compensate an offset level of the touch sensing device 100 at a time. First, the control unit 122 may calculate a difference between an input offset level and a target offset level, divide the calculated level difference by a reference offset variation amount, and determine an offset compensation value of the touch sensing device 100 according to the divided result (hereinafter, referred to as a compensation value).

Herein, the reference offset variation amount may indicate an offset value varied when compensation is performed once. For example, in the event that an offset level of the touch sensing device 100 is compensated twice and an actually varied offset level is 10, the reference offset variation amount may be 5. In exemplary embodiments, the reference offset variation amount may be a predetermined value.

In exemplary embodiments, as a compensation value becomes large, the control unit 122 may enlarge an increment of an offset level of the touch sensing device 100. That is, as a compensation value becomes large, the control unit 122 may enlarge an offset compensation level. On the other hand, as a compensation value becomes small, the control unit 122 may reduce an increment of an offset level of the touch sensing device 100. That is, as a compensation value becomes small, the control unit 122 may reduce an offset compensation level.

With the above description, the control unit 122 may increase or decrease an offset compensation level in proportion to a difference between an input offset and a target offset. Thus, an offset level of the touch sensing device 100 may reach a target offset level through an offset compensation operation under the control of the control unit 122. As a result, it is possible to shorten an offset compensation time of the touch sensing device 100.

In the event that the touch sensing device is connected with various electronic devices, its offset compensation time may be kept identically. The reason may be that an offset is compensated according to a level difference between an input offset and a target offset regardless of an electronic device connected with the touch sensing device 100. That is, it is possible to remove a deviation of an offset compensation time according to an electronic device connected with the touch sensing device 100.

The storage unit 123 may store reference data. For example, the storage unit 123 may store node deviations of sensing nodes. Further, the storage unit 123 may store a reference value determined according to touch data. Also, the storage unit 123 may store a target offset level of the touch sensing device 100. Also, the storage unit 123 may store a reference offset variation amount of the touch sensing device 100.

In exemplary embodiments, the storage unit 123 may include a hard disk drive, a flash memory, or a nonvolatile memory such as a solid state drive (SSD).

With the above-described touch sensing device, it is possible to exactly sense a touch state of a touch panel by reflecting an error of no-touch data according to a variation in a circumstance. Also, the offset compensation performance may be improved by shortening an offset compensation time of the touch sensing device 100.

FIG. 2 is a block diagram schematically illustrating a touch panel unit in FIG. 1. Referring to FIG. 2, a touch panel unit 110 may include a driver 111, a receiver 112, and a sense node array 113.

The sense node array 113 may include a plurality of sensing nodes arranged at intersections of a plurality of TX driving lines 111a, 111b, 111c, and 111d and a plurality of RX driving lines 112a, 112b, 112c, 112d. A sensing node 113a may have mutual capacitance 113b which varies according to a driving current flowing via the TX driving line 111a and an external factor. Herein, the external factor may include a user touch and a noise. The sensing nodes of the sensing node array 113 may be configured identically.

The driver 111 may provide a driving current to the plurality of TX driving lines 111a, 111b, 111c, and 111d.

The receiver 112 may receive mutual capacitance values of the sensing nodes via the plurality of RX driving lines 112a, 112b, 112c, 112d. Herein, an electrical signal may be a voltage or a current. A magnitude of an electrical signal may be varied according to a mutual capacitance value of a sensing node. The receiver 112 may provide the received mutual capacitance values to a panel scan unit 120.

With the above description, the touch panel unit 110 may sense mutual capacitance values of sensing nodes to provide it to the panel scan unit 120.

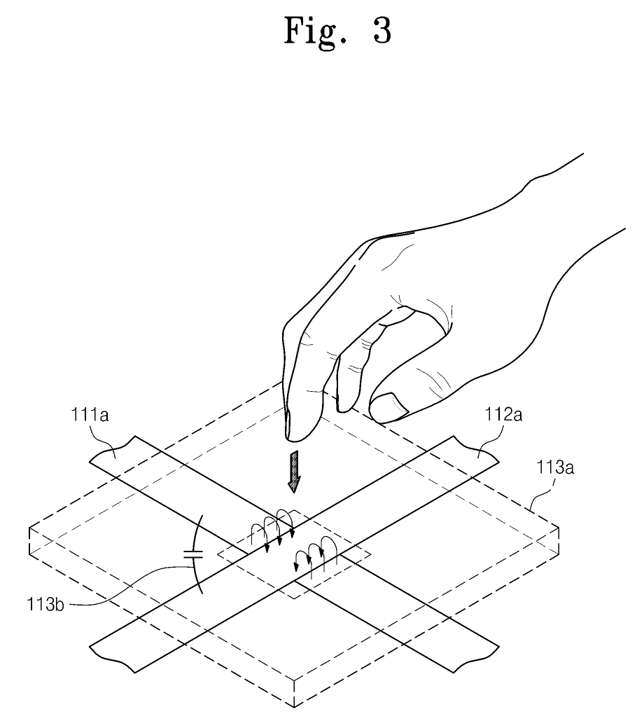

FIG. 3 is a detailed diagram illustrating a sensing node in FIG. 2. Referring to FIG. 3, a sensing node 113a may be formed at an intersection of a TX driving line 111a and an RX sensing line 112a. The sensing node 113a may have mutual capacitance 113b corresponding to the sensing node 113a.

To detect a touch state of the sensing node 113a, a driving current may be provided to the TX driving line 111a. At this time, the RX sensing line 112a may generate an electrical signal indicating a touch output value. The electrical signal may differentiate according to the mutual capacitance 113b of the sensing node 113a. The mutual capacitance 113b of the sensing node 113a when the sensing node 113a is not touched may be smaller than that when the sensing node 113a is touched.

With the above description, a touch state of the sensing node 113a may be judged by detecting and analyzing an electrical signal provided via the RX sensing line 112a.

FIG. 4 is a block diagram illustrating a signal process unit in FIG. 1. Referring to FIG. 4, a signal process unit 121 may include an amplifier 121a, a demodulator 121b, and an analog-to-digital converter (hereinafter, referred to as ADC) 121c.

The amplifier 121a may amplify a signal input to the signal process unit 121 to provide the amplified signal to the demodulator 121b. The demodulator 121b may perform an analog filtering operation on the amplified signal to remove a noise. The ADC 121c may convert the filtered analog signal into a digital signal. The ADC 121c may provide the converted digital signal as touch data. The touch data provided by the ADC 121c may include mutual capacitance values of sensing nodes in a sensing node array 113 or data associated with signals corresponding thereto.

With the above description, the signal process unit 121 may convert an analog signal input from a touch panel unit 100 into a digital signal. In example embodiments, the converted digital signal may be touch data indicating a touch state of each sensing node (or, a touch panel).

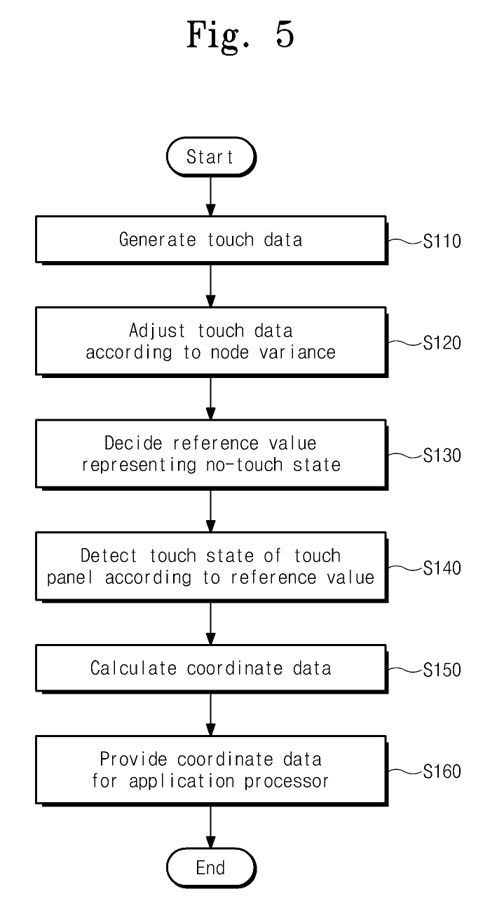

FIG. 5 is a flowchart illustrating a control method of a touch sensing device according to an exemplary embodiment.

In operation S110, a touch sensing device 100 may receive a sensing signal from a touch panel unit 110. Herein, the sensing signal may indicate a mutual capacitance value of a sensing node provided from the touch panel unit 110. The signal process unit 121 may convert the sensing signal to generate touch data.

In operation S120, a control unit 122 may receive the touch data. The control unit 122 may read node deviations of sensing nodes of the touch panel unit 110 from a storage unit 123. The node deviations of sensing nodes may mean mutual capacitance values when sensing nodes are not touched or deviations of electrical signals corresponding thereto. The control unit 122 may correct touch data based on the read node deviations. The control unit 122 may correct the touch data by adding the read node deviations to the touch data.

In operation S130, the control unit 122 may determine a reference value based on the corrected touch data. Herein, the reference value may indicate a mutual capacitance value of a sensing node not touched or a magnitude of a sensing signal corresponding thereto.

A reference value may be determined as follows. Touch data may include a mutual capacitance value of a sensing node touched by a user and a mutual capacitance value of a sensing node not touched. In general, a mutual capacitance value of a touched sensing node may be smaller than that of a sensing node not touched.

Thus, the possibility that a relatively large value of touch data indicates a mutual capacitance value of a sensing node not touched may be high. For this reason, a touch state of a touch panel may be judged by determining a relatively large value of touch data as a reference value, and comparing the determined reference value to a magnitude of another touch data.

In exemplary embodiments, the control unit 122 may determine a maximum value of the corrected touch data as a reference value.

In exemplary embodiments, the control unit 122 may determine a value within a predetermined range from a maximum value of the corrected touch data as a reference value.

In operation S140, the control unit 122 may judge a touch state of sensing nodes in the touch panel unit 110 based on the reference value.

In exemplary embodiments, when a difference between the reference value and a magnitude of touch data is greater than a predetermined value, the touch data may be judged to be touch data indicating a touch state. When a difference between the reference value and a magnitude of touch data is less than a predetermined value, the touch data may be judged to be touch data indicating a no-touch state. A touch state of the sensing nodes may be judged according to the above-described judgment result.

In operation S150, the control unit 122 may calculate touch coordinates of touched sensing nodes.

In operation S160, the control unit 122 may provide the calculated touch coordinates to an application process unit 200. The application process unit 200 may perform a required application operation based on the provided touch coordinates.

With the control method of the touch sensing device, a reference value for judging a touch state may be determined in light of a node deviation of a sensing node. In this case, the reference value may be a value included in touch data. Since a touch state is exactly judged by reflecting an error of no-touch data according to a circumstance variation to the reference value, a sensing error of the touch sensing device 100 may be reduced.

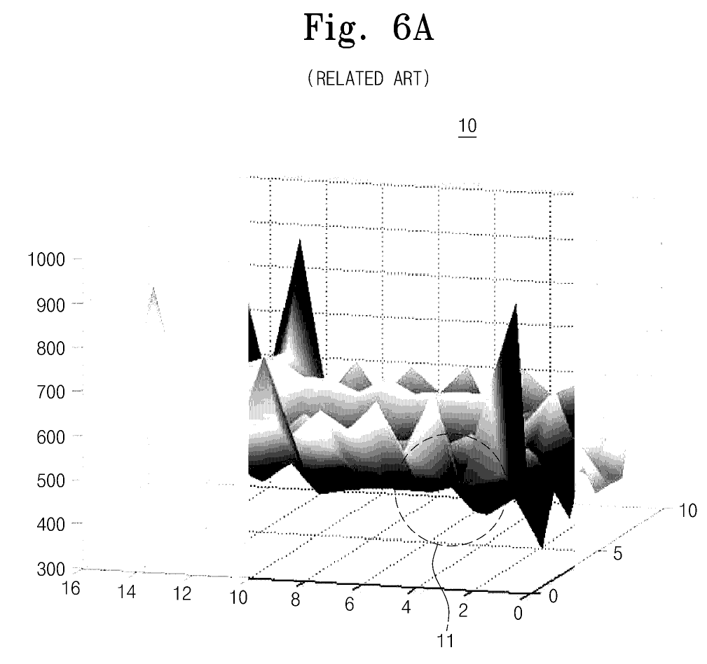

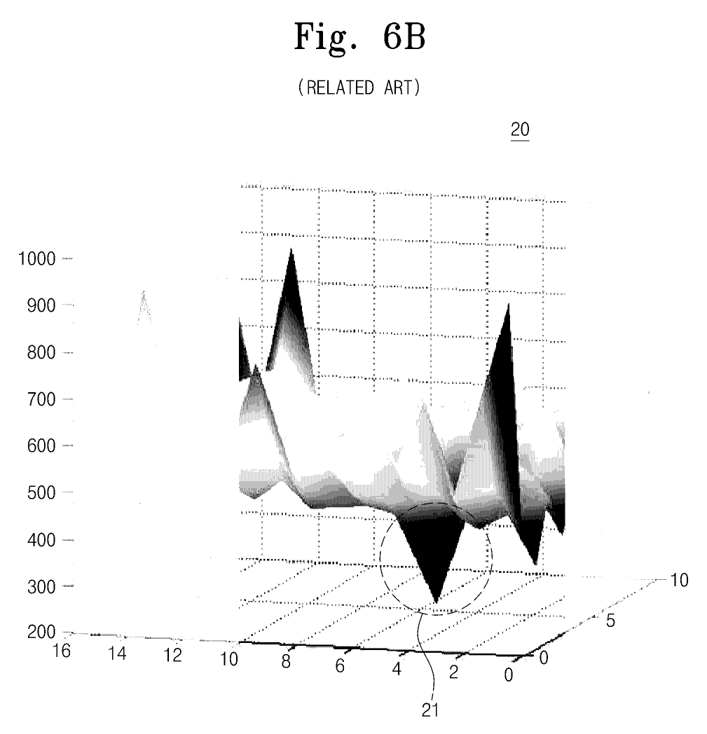

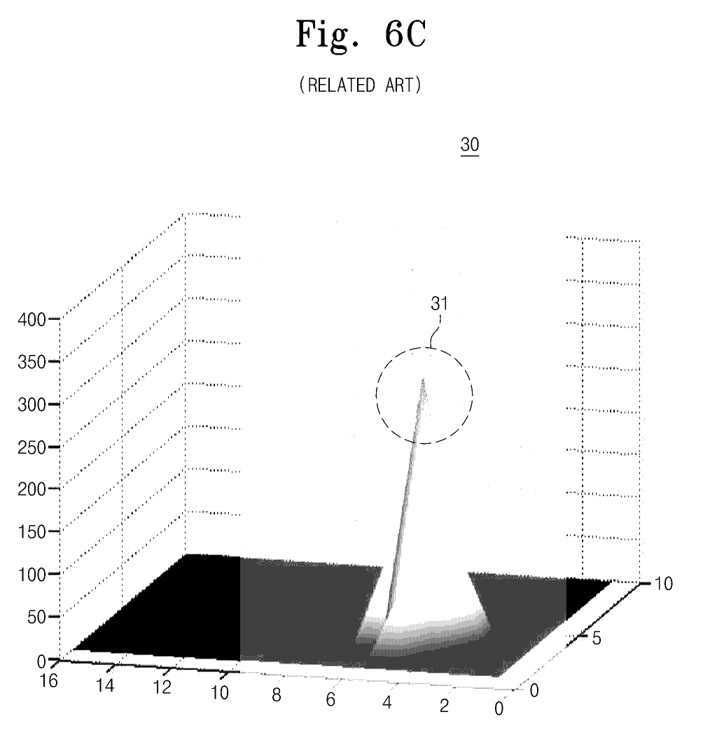

FIGS. 6A to 6C are diagrams for describing a control method of a conventional touch sensing device. FIG. 6A shows no-touch data 10 of a conventional touch sensing device, FIG. 6B shows touch data 20 received from the touch sensing device, and FIG. 6C shows state data 30 calculated on the basis of no-touch data and touch data.

A control method of the conventional touch sensing device may use predetermined no-touch data 10 to judge a touch state of a touch panel. Herein, the no-touch data 10 may be a value obtained by reading a mutual capacitance value of each sensing node at a specific point of time, and may be used for comparison with the touch data 20. That is, if no-touch data 10 and touch data 20 at any sensing node are equal to each other, the sensing node may be judged to be a sensing node that is not touched. On the other hand, in case that a value of touch data 20 of any sensing node is substantially smaller than that of no-touch data 10 thereof, the sensing node may be judged to be a touched sensing node. The read no-touch data 10 may be stored at a storage unit 123.

Below, a method of judging a touch state of a sensing node will be described. FIG. 6A indicates no-touch data 10 of a touch sensing device 100. A first value 11 included in the no-touch data 10 may be assumed to be no-touch data of a sensing node. Herein, the sensing node may be one of a plurality of sensing nodes included in the touch sensing device 100. As described above, the first value 11 may indicate a mutual capacitance value of a sensing node read under the condition that the sensing node is not touched.

FIG. 6B illustrates touch data 20 of the touch sensing device 100. The touch data 20 may be data obtained by reading mutual capacitance values of sensing nodes included in the touch sensing device 100. The touch data 20 may include a mutual capacitance value of a touched sensing node or sensing nodes not touched.

In FIG. 6B, a second value 21 included in the touch data 20 may be assumed to be touch data of a sensing node. Likewise, the second value 21 may be a value obtained by reading a mutual capacitance value of a sensing node. At this time, the sensing node may be a touch state or a no-touch state.

FIG. 6C illustrates state data 30 of the touch sensing device 100. In exemplary embodiments, the state data 30 may be obtained by subtracting the touch data 20 from the no-touch data 10. Thus, the state data 30 may indicate a difference between a mutual capacitance value read at a no-touch state of the sensing node and a mutual capacitance value newly read at a touch state judging operation.

In FIG. 6C, a third value 31 included in the state data 30 may be assumed to be state data of a sensing node. At this time, the third value of the sensing node (i.e., state data) may be obtained by the following equation 1.

V₃=V₁−V₂=V₁−(Vᵢₙₕₑᵣₑₙₜ−ΔCap+Noise) [Equation 1]

In the equation 1, V3 may indicate the third value 31. V₁ may indicate the first value 11, and may be a mutual capacitance value of a sensing node read in advance at a no-touch state. V₂ may indicate the second value 21, and may be a mutual capacitance value of a sensing node newly read to judge a touch state. ΔCap may indicate a mutual capacitance variation amount due to a touch. Vᵢₙₕₑᵣₑₙₜ may indicate an inherent value of a sensing node. The second value may be considered to include an inherent value Vᵢₙₕₑᵣₑₙₜ of a sensing node at a newly read point, a mutual capacitance variation amount ΔCap due to a touch, and a noise. Herein, the inherent value may indicate a mutual capacitance value at the condition that a sensing node is not touched.

In the event that factors (e.g., a circumstance variation) of changing the inherent value are eliminated, the inherent value may be equal to the first value 11. In this case, the equation 1 may be rewritten like the following equation 2.

V₃=ΔCap−Noise [Equation 2]

Herein, a mutual capacitance variation amount due to a touch may be a value determined according to a touch state of a sensing node. That is, when a sensing node is not touched, a mutual capacitance variation amount may be ‘0’. When a sensing node is touched, a mutual capacitance variation amount may be larger than ‘0’.

The touch sensing device 100 may judge a touch state of a sensing node according to the third value 31 calculated using the equation 2. For example, when a sensing node is at a no-touch state, the third value 31 may only include a noise component. Thus, the third value may be relatively small. On the other hand, when a sensing node is at a touch state, the third value 31 may include a mutual capacitance variation amount due to a touch and a noise. Since the mutual capacitance variation amount is larger than a nose, the third value may be relatively large. Since the third value is varied according to whether a sensing node is touched, a touch state may be judged using the third value.

In the conventional touch sensing device 100, however, it is impossible to detect a touch state exactly when a mutual capacitance value of a sensing node is changed. At this time, an inherent value may be considered to be a sum of an original inherent value and a circumstance variation amount. In this case, the equation 1 indicating the third value 31 may be expressed by the following equation 3.

$$\begin{matrix}{V}_{3} = {V}_{1} - ( {V}_{inherent} - Δ Cap + Noise ) \\ = {V}_{1} - ( {V}_{1} + CV - Δ Cap + Noise ) \\ = Δ Cap - Noise - CV\end{matrix} \qquad [ Equation 3 ]$$

In equation 3, CV may indicate a circumstance variation amount. First and second sections may be equal to the equation 2. However, a third value 31 in a third section may be different from the equation 2. That is, an unpredicted error such as a circumstance variation amount may arise. In particular, when the circumstance variation amount is large, a sensing performance of the touch sensing device 100 may be lowered, thus causing an abnormal operation frequently.

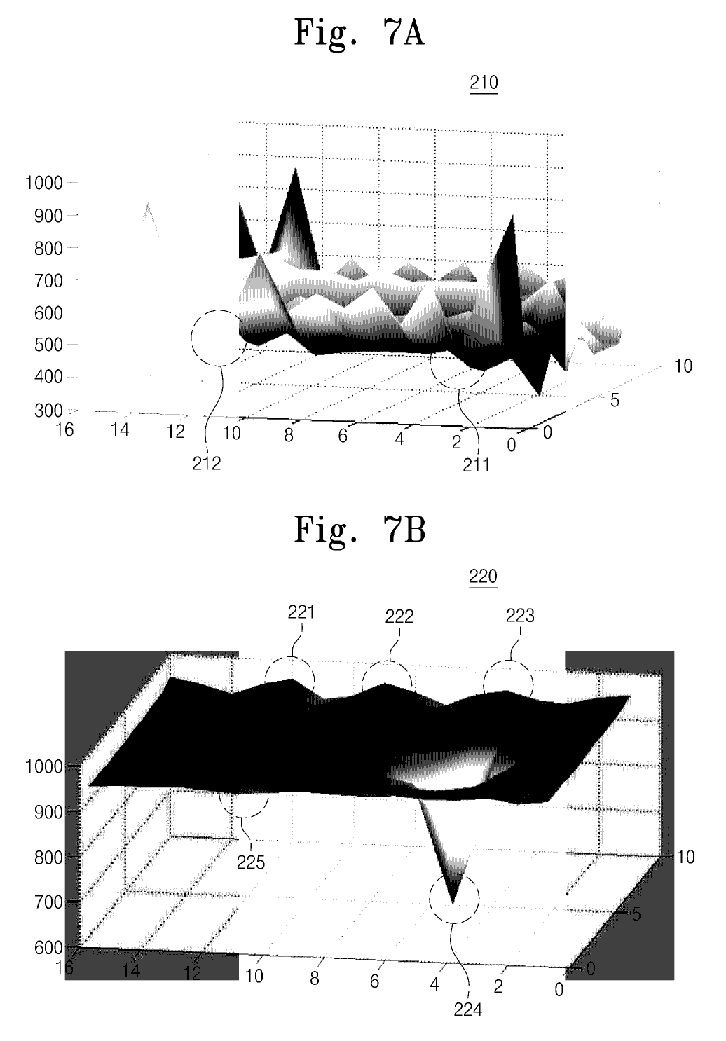

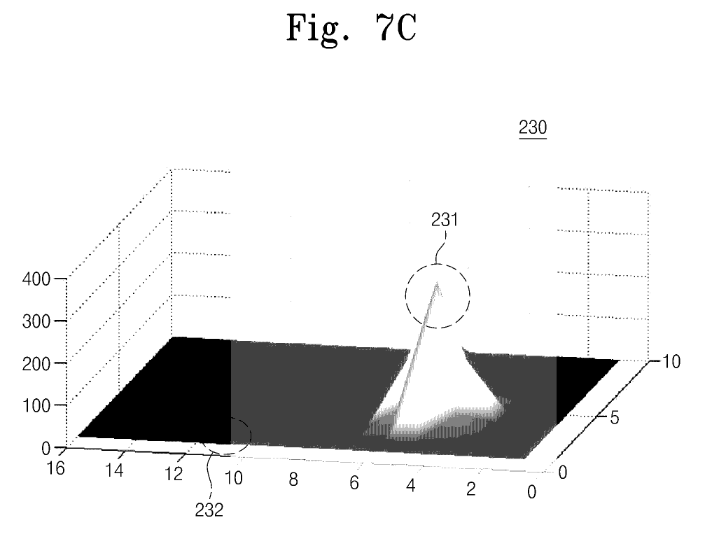

FIGS. 7A to 7C are diagram for describing a touch coordinate calculating method of a touch sensing device according to an exemplary embodiment. FIG. 7A illustrates touch data 210 provided to a touch sensing device, FIG. 7B indicates touch data 220 corrected using a node deviation, and FIG. 7C illustrates state data 230 calculated using the corrected touch data 220.

A control method of a touch sensing device according to an exemplary embodiment may not use predetermined no-touch data to judge a touch state of a touch panel. Instead, a reference value for judging a touch state may be calculated from input touch data 220. This will be more fully described below.

Herein, the reference value may correspond to no-touch data in a conventional touch sensing device. However, no-touch data in a conventional touch sensing device may not reflect a circumstance variation amount, while the reference value of the exemplary embodiment may reflect a circumstance variation amount. In detail, the reference value may indicate a mutual capacitance value of a specific sensing node of a plurality of sensing nodes. The circumstance variation amounts of sensing nodes may be nearly identical to one another. Thus, the reference value may include the circumstance variation amount. Since the circumstance variation amount is included in common in a reference value and an inherent value, an error component, such as the circumstance variation amount, may be removed according to a subtraction result.

Below, a control of a touch sensing device according to an exemplary embodiment will be described.

FIG. 7A illustrates touch data 210 provided to a touch sensing device. The touch data 210 may be data obtained by reading mutual capacitance values of sensing nodes included in the touch sensing device 100. The touch data 210 may include a mutual capacitance value of a touched sensing node or sensing nodes not touched.

It is assumed that first touch data 211 included in the touch data 210 is touch data of a first sensing node. Likewise, it is assumed that second touch data 212 included in the touch data 210 is touch data of a second sensing node. At this time, the first and second touch nodes may be at a touch state or a no-touch state. The first and second sensing nodes may be included in a touch panel unit 110.

FIG. 7B indicates touch data 220 corrected using a node deviation. Herein, the corrected touch data 220 may be obtained by adding a node deviation of each sensing node to the touch data 210. A node deviation of a sensing node may be the same as described above. The corrected touch data may be calculated to determine a reference value using a mutual capacitance value of a sensing node at a no-touch state calculated from the touch data.

First corrected data 224 included in the corrected touch data 220 may be assumed to be touch data of the first sensing node. Likewise, second corrected data 225 included in the corrected touch data 220 may be assumed to be touch data of the second sensing node. The first and second corrected data 224 and 225 may be calculated by the following equation 4.

CD1=TD1+ND1

CD2=TD2+ND2 [Equation 4]

In equation 4, CD1 may indicate the first corrected data 224, CD2 may indicate the second corrected data 225, TD1 may indicate the first touch data 211, TD2 may indicate the second touch data 212, ND1 may indicate a first node deviation, and ND2 may indicate a second node deviation. Herein, the first and second node deviations may indicate node deviations of the first and second sensing nodes, respectively.

The first and second corrected data 224 and 225 may be values obtained by correcting node deviations. If the first and second sensing nodes are not touched, the first and second corrected data 224 and 225 may be equal to each other. If the first and second sensing nodes are touched, the first and second corrected data 224 and 225 may be different from each other.

When a sensing node is touched, a mutual capacitance value of the touched sensing node may decrease. If a value of the second corrected data 225 is larger by a predetermined value than that of the first corrected data 224, the chance that the second sensing node is at a no-touch state may be high. In other words, if a value of the first corrected data 224 is smaller by a predetermined value than that of the second corrected data 225, the chance that the first sensing node is at a touch state may be high.

The touch sensing device 100 may determine a reference value referring to the corrected touch data 220. As described above, the reference value may be a value for judging a touch state of a touch panel, and may correspond to no-touch data 10 in a conventional touch sensing device. No-touch data 10 in a conventional touch sensing device may be measured at a specific point of time in advance, while the reference value of the exemplary embodiment may be a value determined using the touch data 210 (in detail, the corrected touch data 220). Also, the no-touch data 10 in a conventional touch sensing device may include values corresponding to a plurality of sensing nodes, while the reference value of the exemplary embodiment may be a common value applied in common to respective nodes. That is, the conventional touch sensing device may need no-touch data corresponding to each sensing node. On the other hand, the reference value of the exemplary embodiment may be applied to all sensing nodes in common.

Below, a method of obtaining a reference value will be described.

Referring to FIG. 7B, the corrected touch data 220 may include the first and second corrected data 224 and 225 and corrected data 221, 222, and 223 of other sensing nodes. Each corrected data may be such a value that a node deviation is corrected. Thus, when sensing nodes are at a no-touch state, corresponding corrected data may have the same value.

As described above, since a touched sensing node has a relatively small mutual capacitance value, corrected data of the touched sensing node may have a relatively small value. Thus, the touch sensing device 100 may determine one, having a relatively large value, from among the corrected data 221, 222, 223, 224, and 225 as a reference value. For example, values of the corrected data 221, 222, 223, and 225 may be relatively larger than that of the corrected data 224. Thus, one of the corrected data 221, 222, 223, and 225 may be selected as a reference value.

In exemplary embodiments, one of the corrected touch data 220, having a maximum value, may be determined as a reference value. The larger a value of corrected data, the higher the chance that a sensing node is at a no-touch state. For this reason, it is preferable to determine a maximum value of the corrected touch data 220 as a reference value. Also, a standard of determining a reference value may become clear. For example, corrected data, having the largest value, of the corrected data 221, 222, 223, and 225 may be determined as a reference value.

In other exemplary embodiments, the touch sensing device 100 may determine a value of the corrected touch data, that is not a maximum value, as a reference value. For example, a fifth largest value of the corrected touch data 220 may be determined as a reference value. Upon comparison with the number of all sensing nodes included in the touch sensing device 100, in general, the number of touched sensing nodes may be few. Therefore, although a value smaller than the maximum value is selected, the selected value may indicate corrected data of a sensing node at a no-touch state.

FIG. 7C illustrates state data 230 calculated using the corrected touch data 220. The state data 230 may be obtained by subtracting the corrected touch data 220 from the reference value (e.g., corrected data 221). Thus, the state data 230 may indicate a difference between a mutual capacitance value (or, the reference value) of a sensing node at a no-touch state and a mutual capacitance value (or, corrected data) of a sensing node to be judged.

In FIG. 7C, a first state value 231 included in the state data 230 may be assumed to be state data of a first sensing node. In this case, the first state value 231 may be obtained by the following equation 5.

SV1=REF−CD1 [Equation 5]

In equation 5, SV1 may indicate a first state value 231, REF may indicate a reference value 221, and CD1 may indicate first corrected data 224. Herein, the reference value 221 and the first corrected data 224 may include corresponding node deviation and circumstance variation amount, respectively.

The circumstance variation amounts of the reference value 221 and the first corrected data 224 may be nearly equal to each other. Thus, the equation 5 may be rewritten by the following equation 6.

SV1=(Vᵢₙₕₑᵣₑₙₜ₂−ND2−CVA)−(Vᵢₙₕₑᵣₑₙₜ₁+ND1+Noise−ΔCap−CVA)

In equation 6, Vᵢₙₕₑᵣₑₙₜ₁ may indicate a first inherent value, Vᵢₙₕₑᵣₑₙₜ₂ may indicate a second inherent value, ND1 may indicate a first node deviation, ND2 may indicate a second node deviation, and CVA may indicate a circumstance variation amount. Herein, the first and second inherent values may indicate inherent values of the first sensing node and a reference node (a sensing node corresponding to the reference value), respectively. The first and second nod deviations may indicate node deviations of the first sensing node and the reference node, respectively. Considering meaning of the node deviation, a sum of the first inherent value and the first node deviation may be equal to a sum of the second inherent value and the second node deviation. Thus, the equation 6 may be rewritten by the following equation 7.

SV1=CVA−(Noise−ΔCap+CVA)=ΔCap+Noise [Equation 7]

Referring to equation 7, the circumstance variation amount included in the first corrected data 224 may be removed. Thus, an error of the first state value 231 due to the circumstance variation amount may be removed.

A value of the first corrected data 224 may be smaller than the reference value 221. Thus, the first state value 231 may have a large value exceeding a predetermined value. In this case, if the first state value 231 is over a predetermined value, the first sensing node may be judged to be at a touch state.

Likewise, a second state value 232 on a second sensing node may be calculated in the same manner as described above. The second corrected data 225 may have a value similar to the reference value 221. The second state value 232 calculated through the same procedure as the first state value 231 may be very small. In this case, if the second state value 232 is below a predetermined value, the second sensing node may be judged to be at a no-touch state.

There is described a control method of a touch sensing device including determining a reference value and judging a touch state of a sensing node according to the reference value. With the control method of the exemplary embodiment, it is possible to prevent state data 230 from be affected by a circumstance variation. Thus, although a mutual capacitance value of a no-touch state is varied due to a circumstance variation, it is possible to exactly judge a touch state of a touch panel.

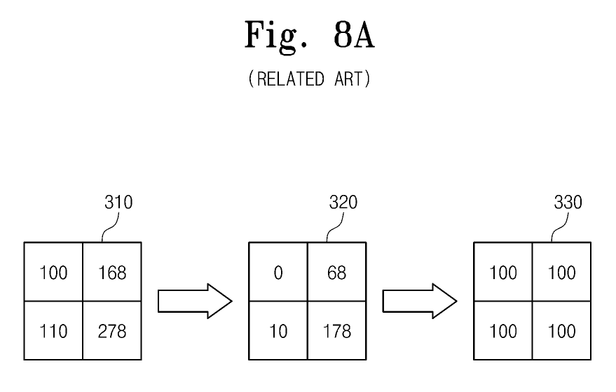

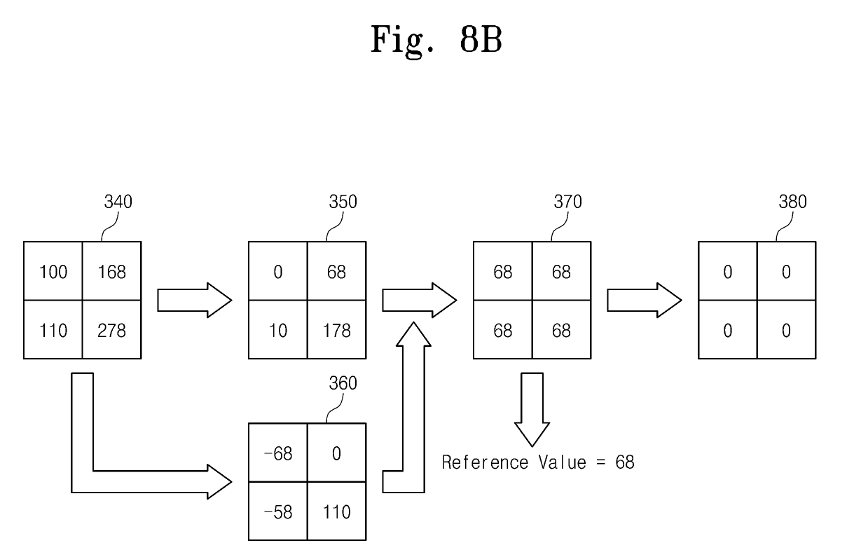

FIGS. 8A and 8B are diagram for describing methods of controlling a touch sensing device.

FIG. 8A shows a control method of a conventional touch sensing device. Referring to FIG. 8A, no-touch data 310 may indicate no-touch data of sensing nodes. The touch data 320 may be touch data of sensing nodes. For ease of description, the sensing nodes may be assumed to be at a no-touch state. Although the touch data 320 is touch data of sensing nodes not touched, a circumstance variation amount according to a peripheral circumstance may be added to the touch data 320. Herein, the circumstance variation amount may be assumed to be 100. With this assumption, the touch data 320 may have a value obtained by subtracting 100 due to the circumstance variation amount from original no-touch data.

With a conventional touch sensing device, touch data 320 may be subtracted from no-touch data 310 to calculate state data. The calculated state data may be illustrated in FIG. 8A. Herein, it is assumed that when a value of state data 330 is over 50 a sensing node corresponding to the state data 330 is judged to be at a touch state. Thus, although sensing nodes are at a no-touch state, they may be abnormally judged to be at a touch state.

FIG. 8B shows a control method of a touch sensing device according to an exemplary embodiment. Referring to FIG. 8B, no-touch data 340 may indicate no-touch data of sensing nodes. Herein, the no-touch data 340 may be used to describe node deviations of sensing nodes and a circumstance variation amount. In the control method of the exemplary embodiment, the no-touch data 340 may be stored or not referred.

Touch data 350 may be touch data of sensing nodes. For ease of description, the sensing nodes may be assumed to be at a no-touch state. Although the touch data 350 is touch data of sensing nodes not touched, a circumstance variation amount according to a peripheral circumstance may be added to the touch data 350. Herein, the circumstance variation amount may be assumed to be 100. With this assumption, the touch data 350 may have a value obtained by subtracting 100 due to the circumstance variation amount from original no-touch data 340.

Node deviation data 360 may indicate a node deviation of each sensing node. If a node deviation is calculated using a touch data value of 168, a node deviation of each sensing node may be as illustrated by the node deviation data 360.

The touch sensing device 100 of the exemplary embodiment may correct a node deviation using the node deviation data 360 when the touch data 350 of sensing nodes is received. In exemplary embodiments, correction of the node deviation may be performed by subtracting the node deviation from the input touch data. A corrected result of the node deviation may become corrected touch data 370.

The touch sensing device 100 may determine a reference value based on the corrected touch data 370. In exemplary embodiments, the reference value may be a maximum value of the corrected touch data 370. Since the maximum value is 68, the reference value may be 68.

The touch sensing device 100 may calculate state data 380 based on the reference value. In exemplary embodiments, the state data 380 may be calculated by subtracting the corrected touch data 370 from the reference value.

The touch sensing device 100 may judge a touch state of a sensing node based on the state data 380. Since values of all state data 380 are smaller than 50, all sensing nodes may be judged to be at a no-touch state.

With the above description, although a circumstance variation amount is added to touch data, it is possible to judge a touch state rightly. Thus, it is possible to prevent an abnormal operation of a touch sensing device due to a peripheral circumstance.

All values of the corrected touch data 370 may be illustrated to have the same value. The reason may be that a node deviation is corrected and all sensing nodes are assumed to be at a no-touch state. However, the exemplary embodiment is not limited thereto. For example, the exemplary embodiment may be also applied to the case that some sensing nodes are at a touch state and values of the corrected touch data 370 are different.

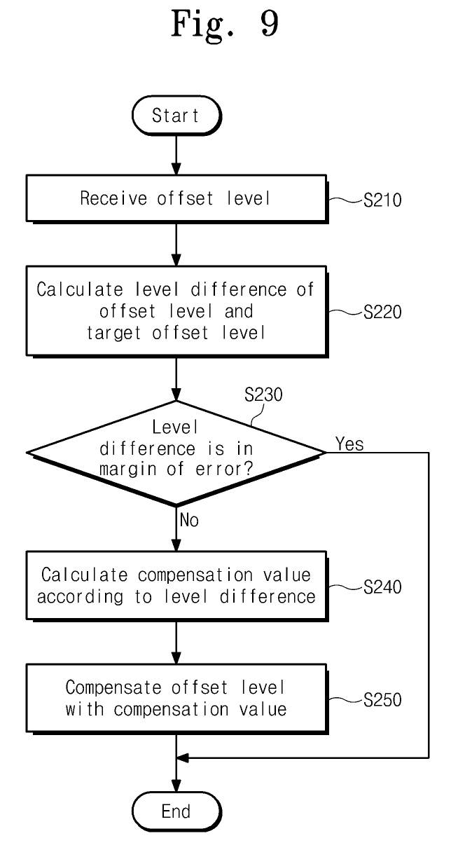

FIG. 9 is a flowchart illustrating a control method of a touch sensing device according to another exemplary embodiment. Below, a control method of a touch sensing device according to another exemplary embodiment will be described with reference to accompanying drawings.

In operation S210, a control unit 122 may receive offset levels of sensing nodes from a touch panel unit 110.

In operation S220, the control unit 122 may calculate a level difference between the input offset levels and a target offset level. The target offset level may be read from a storage unit 123.

In operation S230, the control unit 122 may judge whether the calculated level difference is within an error range. If the calculated level difference is within an error range, the method may be ended. If the calculated level difference is not within an error range, the method proceeds to operation S240.

In operation S240, the control unit 122 may calculate a compensation value according to the calculated level difference. The compensation value may be obtained by dividing the calculated level difference by a reference offset variation amount. Herein, the reference offset variation amount may indicate an offset size varied per one compensation unit. In exemplary embodiments, the reference offset variation amount may be a predetermined value. The compensation value may be calculated in the same manner as described with reference to FIG. 1.

In operation S250, the control unit 122 may compensate an offset level of the touch sensing device according to the calculated compensation value.

In exemplary embodiments, the larger the compensation value, the more an increment of an offset level of the touch sensing device 100. On the other hand, the smaller the compensation value, the less an increment of an offset level of the touch sensing device 100. The offset level of the touch sensing device 100 may be compensated in the same manner as described with reference to FIG. 1.

With the control method of the touch sensing device 100, a time taken to compensate an offset of the touch sensing device 100 is shortened. Also, in the event that the touch sensing device is connected with various electronic devices, a time taken to compensate an offset of the touch sensing device 100 may be kept to be constant.

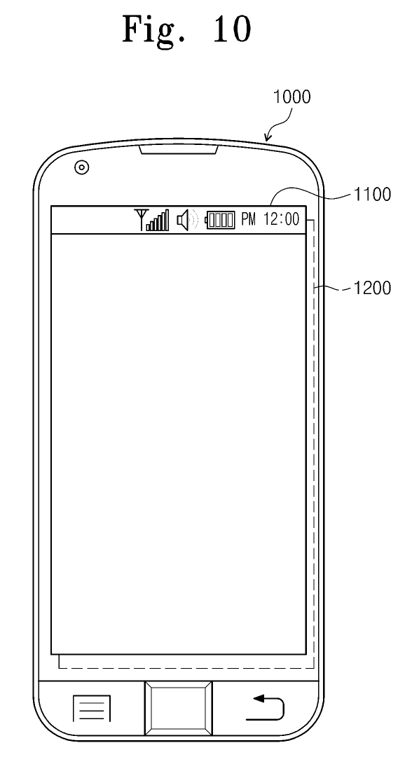

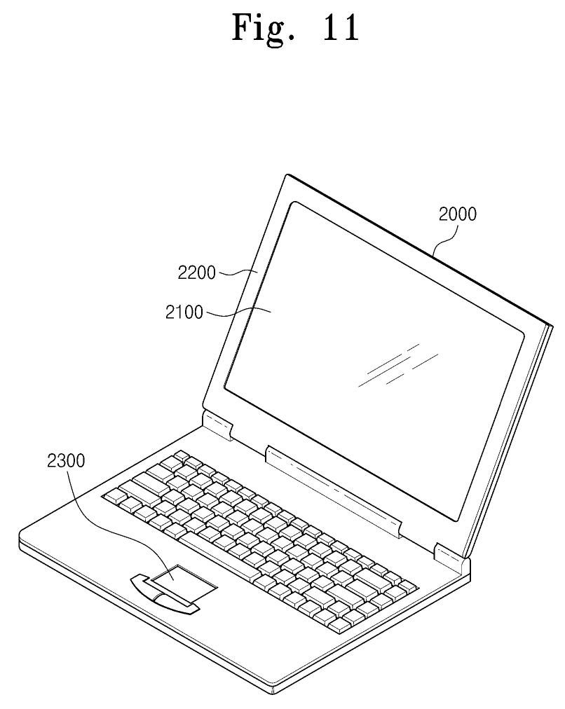

FIG. 10 is a diagram schematically illustrating a handheld phone to which a touch sensing device is applied. Referring to FIG. 10, a handheld phone 1000 may include a touch panel unit 1100 and a panel scan unit 1200.

The touch panel unit 1100 may provide a user interface under the control of an application process unit (not shown). The touch panel unit 1100 may include a plurality of sensing nodes. The touch panel unit 1100 may sense a user touch to provide the panel scan unit 1200 with an electrical signal indicating a variation in mutual capacitance of a sensing node.

The panel scan unit 1200 may judge a touch state of a sensing node based on the electrical signal. The panel scan unit 1200 may calculate a coordinate of a touched sensing node to provide it to the application process unit.

The panel scan unit 1200 may be configured the same as described with reference to FIG. 1.

With the above description, the handheld 1000 including the touch sensing device may reduce a touch sensing error due to a circumstance variation. Thus, a touch sensing performance of the handheld 1000 is increased.

FIG. 11 is a diagram schematically illustrating a personal computer to which a touch sensing device is applied. Referring to FIG. 11, a personal computer 2000 may include a first touch panel unit 2100, a panel scan unit 2200, and a second touch panel unit 2300.

The first touch panel unit 2100 may provide a user interface under the control of an application process unit (not shown). The first touch panel unit 2100 may include a plurality of sensing nodes. The first touch panel unit 2100 may sense a user touch to provide the panel scan unit 2200 with an electrical signal indicating a variation in mutual capacitance of a sensing node.

The second touch panel unit 2300 may include a plurality of sensing nodes. Likewise, the second touch panel unit 2300 may sense a user touch to provide the panel scan unit 2200 with an electrical signal indicating a variation in mutual capacitance of a sensing node.

The panel scan unit 2200 may judge a touch state of a sensing node of the first or second touch panel unit 2100 or 2300 based on the electrical signal provided from the first or second touch panel unit 2100 or 2300. The panel scan unit 2200 may calculate a coordinate of a touched sensing node to provide it to the application process unit.

The panel scan unit 2200 may be configured the same as described with reference to FIG. 1.

With the above description, the personal computer 2000 including the touch sensing device may reduce a touch sensing error due to a circumstance variation. Thus, a touch sensing performance of the personal computer 2000 is increased.

While the present disclosure has been described with reference to exemplary embodiments, it will be apparent to those skilled in the art that various changes and modifications may be made without departing from the spirit and scope of the present invention. Therefore, it should be understood that the above exemplary embodiments are not limiting, but illustrative.

What is claimed is:

1. A method of controlling a touch sensing device, the method comprising:
determining a first corrected capacitance value that is a difference between a first capacitance value of a first sensing node and a first node deviation of the first sensing node and a second corrected capacitance value that is a difference between a second capacitance value of a second sensing node and a second node deviation of the second sensing node;
determining one of the first corrected capacitance value of the first sensing node and the second corrected capacitance value of the second sensing node as a reference value; and
determining a touch state of one of the first sensing node and the second sensing node based on the reference value and the one of the first corrected capacitance value and the second corrected capacitance value

2. The control method of claim 1, wherein the first node deviation is a difference between a capacitance value of a reference node and a capacitance value of the first sensing node when sensing nodes of the touch sensing device are not-touched, the second node deviation is a difference between the capacitance value of the reference node and a capacitance value of the second sensing node when sensing nodes of the touch sensing device are not-touched, the sensing nodes including the first sensing node, the second sensing node and the reference node.

3. The control method of claim 1, wherein the reference value is a maximum value of the first corrected capacitance value and the second corrected capacitance value.

4. The control method of claim 1, wherein the determining the touch state comprises:
determining a state value that is a difference between the reference value and the one of the first corrected capacitance value and the second corrected capacitance value; and
determining that the touch state indicates an occurrence of a touch on the touch panel base on the state value.

5. The control method of claim 4, wherein the determining the touch state further comprises:
calculating a touch coordinate of the touch panel in response to determining that the touch state indicates the occurrence of the touch on the touch panel.

6. The control method of claim 4, wherein the determining that the touch state indicates the occurrence of the touch on the touch panel comprise:
comparing the state value with a comparison value.

7. A touch sensing device, comprising:
a touch panel unit including sensing nodes which include a first sensing node that detects a first capacitance value and a second sensing node that detects a second capacitance value; and
a control unit configured to determine a first corrected capacitance value of the first sensing node that is a difference between the first capacitance value and a first node deviation and a second corrected capacitance value of the second sensing node that is a difference between the second capacitance value and a second node deviation, determine one of the first corrected capacitance value of the first sensing node and the second corrected capacitance value of the second sensing node as a reference value, and determine a touch state of one of the first sensing node and the second sensing node based on the reference value and the one of the first corrected capacitance value and the second corrected capacitance value,
wherein the first node deviation is a difference between a capacitance value of a reference node and a capacitance value of the first sensing node when the sensing nodes are not-touched, the second node deviation is a difference between the capacitance value of the reference node and a capacitance value of the second sensing node when sensing nodes are not-touched, the reference node is one among the sensing nodes.

8. The touch sensing device of claim 7, further comprising:
a storage unit configured to store the first node deviation and the second node deviation.

9. The touch sensing device of claim 7, wherein a touch state of one of the first sensing node and the second sensing node having the reference value is a no-touch state.

10. The touch sensing device of claim 9, wherein the reference value is a maximum value of the first corrected capacitance value and the second corrected capacitance value.

11. The touch sensing device of claim 7, wherein the control unit calculates a touch coordinate of the touch panel unit by determining a difference between the reference value and the one of the first corrected capacitance value and the second corrected capacitance value and comparing the difference with a comparison value.

12. The touch sensing device of claim 7, wherein the touch panel unit comprises:
a sense node array including the sensing nodes arranged at intersections of driving lines and sensing lines;
a driver configured to provide a driving current to the driving lines; and
a receiver configured to sense a capacitance value of the sensing nodes.

13. The touch sensing device of claim 7, wherein the touch panel is a screen on a mobile phone.

14. A control method of a touch sensing device, comprising:
determining capacitance values of sensing nodes of a touch panel in response to a sensing signal from the sensing nodes;
determining corrected values indicating differences between the capacitance values and node deviations of the sensing nodes;
judging a touch state of the sensing nodes based on the corrected values,
wherein the node deviations are differences between a capacitance value of a reference node and capacitance values of the sensing nodes when the sensing nodes are not-touched, the reference node is one among the sensing nodes.

15. The control method of claim 14, wherein the judging the touch state of the sensing nodes comprises:
determining one of the corrected values as a reference value; and
determining state values that are differences between the reference value and the corrected values,
comparing the state values with a comparison value.

16. The control method of claim 15, wherein the reference value is a maximum value of the corrected data.

17. The control method of claim 15, further comprising:
calculating a touch coordinate of the touch panel based on a result of the comparison.

18. A control method of a touch sensing device, comprising:
receiving an offset level from a touch panel;
calculating a level difference between the input offset level and a target offset level; and
varying an offset compensation value of the touch panel according to the level difference.

19. The control method of claim 18, wherein the offset compensation value is determined according to a value obtained by dividing the level difference by a reference offset variation amount.
